(19) United States
(12) Patent Application Publication
(10) Pub. No.: US 2007/0206142 A1
(43) Pub. Date: Sep. 6, 2007

(54) One Mask Display Backplane

(76) Inventor: Willem den Boer, Brighton, MI (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/680,776

(22) Filed: Mar. 1, 2007

Related U.S. Application Data
(60) Provisional application No. 60/779,048, filed on Mar. 3, 2006.

(51) Int. Cl. G02F 1/1343

(52) U.S. Cl. 349/139

(57) ABSTRACT

A single mask process for a display backplane. The process includes depositing a blanket layer of a lateral semiconducting material, and depositing a layer of a conducting material. The conducting material is patterned into pixel electrodes and select lines, where the select lines are spaced from the pixel electrodes by a distance that allows the lateral semiconducting material to function as a diode between the select lines and the pixel electrodes.

### CROSS REFERENCE TO RELATED APPLICATIONS

This application claims the benefit of U.S. Provisional Application No. 60/779,048, filed Mar. 3, 2006, the entirety of which is incorporated by reference.

### BACKGROUND

Liquid crystal display technology provides relatively energy efficient, space efficient, high image-quality displays. Such displays can be used on a device as small as a wrist watch or as large as a multimedia theater display.

Current mainstream active matrix liquid crystal display technology is based on thin film transistor arrays and typically requires a four or five mask process for the active matrix backplane and as many as seven thin film layers. Although three mask thin film transistor processes have been proposed, they have not been commercially successful.

### SUMMARY

The inventor herein has recognized that current thin film transistor liquid crystal display technology is relatively expensive and/or can be difficult to scale to large sizes. These issues can be addressed by using a one mask process to build an active matrix backplane that utilizes a dual select diode circuit. Lateral semiconducting action provides diode characteristics in systems built using this process.

### BRIEF DESCRIPTION OF THE DRAWINGS

FIG. 1 schematically shows a dual select diode circuit.

FIG. 2 shows six pixels of a dual select diode backplane formed using a one mask process that utilizes a lateral semiconducting material.

FIG. 3 shows a cross section of one of the pixels from FIG. 2.

FIG. 4 shows six pixels of a dual select diode backplane formed using a one mask process that utilizes a lateral semiconducting material and low-resistance metal select lines.

FIG. 5 shows a cross section of one of the pixels from FIG. 4.

### WRITTEN DESCRIPTION

The present disclosure is directed to a one mask process for building a dual select diode active matrix backplane. The inventor herein has recognized that this can be accomplished by using the same mask to pattern the pixels and the select lines in a dual select diode circuit. Nonlinear resistors between each pixel and its select lines can be formed by a lateral device based on, for example, a transparent semiconductor, such as Zinc Oxide.

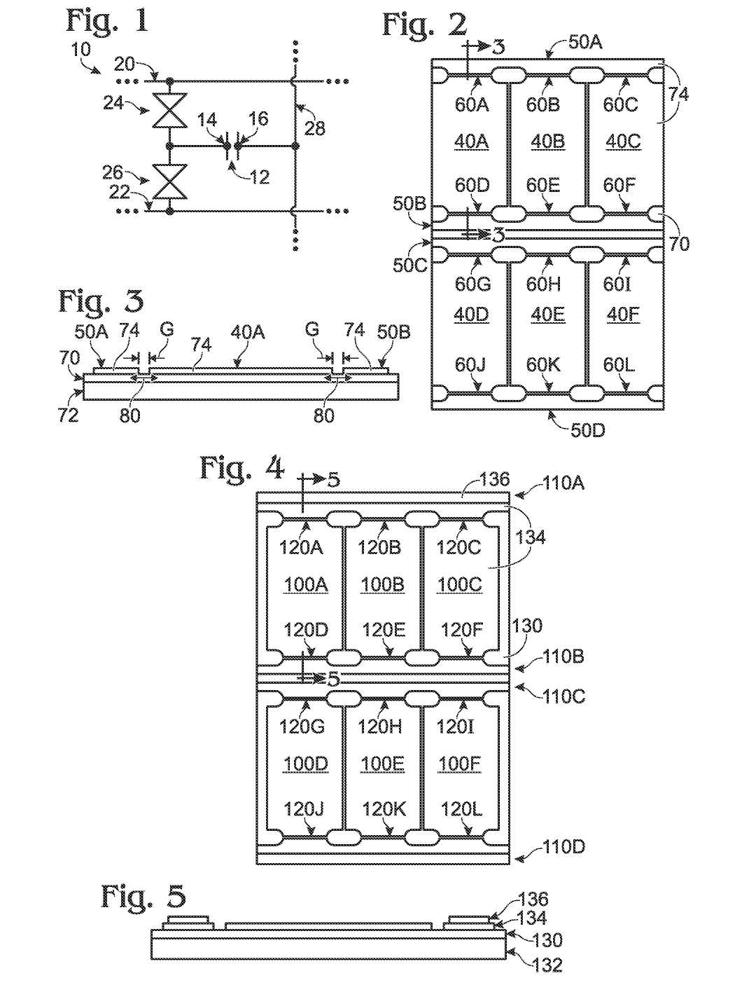

FIG. 1 schematically shows an exemplary pixel 10 that can be built using the herein described one mask process. Pixel 20 is a differential circuit that includes a capacitor 12 having a pixel node 14 and a data node 16. Capacitor 12 can be a constituent element of a light-producing module. The capacitor can be configured to control characteristics of light that is output via the light-producing module. Pixel 10 also includes a first dedicated select line 20 and a second dedicated select line 22. While the illustrated embodiment shows a differential circuit in which each row of pixels has two dedicated select lines, it should be understood that a differential circuit that utilizes shared select lines between adjacent rows of pixels is within the scope of this disclosure.

A first diode 24 operatively connects the first select line to the pixel node of the capacitor, and a second diode 26 operatively connects the second select line to the pixel node of the capacitor. A data line 28 is operatively connected to the data node of the capacitor. The data line and the select lines can be cooperatively controlled to selectively charge the capacitor.

An array of the pixels illustrated in FIG. 1 can be arranged in rows and columns to form a liquid crystal display of a desired resolution. Displays utilizing a differential circuit similar to the one depicted in FIG. 1 can be referred to as dual select diode liquid crystal displays.

Thin film diode liquid crystal displays and dual select diode circuits have earlier been described in U.S. Pat. Nos. 4,731,610; 5,926,236; 6,008,872; 6,222,596; 6,225,968; and 6,243,062; and U.S. Patent Publication Nos. 2005/0083283; 2005/0083321; and 2005/0225543, the entirety of which are incorporated by reference.

The fabrication of a dual select diode active matrix liquid crystal display can be less difficult than that of a thin film transistor display. In particular, dual select diode active matrix liquid crystal displays can be fabricated in fewer mask steps, with relaxed design rules that scale with the display size. When operated in a dual select mode, the pixel circuit can act as an analog switch. The dual select diode circuit is not a two-terminal switching device, but rather a three-terminal switching device, like those that incorporate a thin film transistor. A dual select diode display can offer performance similar to that of a thin film transistor liquid crystal display, with accurate gray shade control, fast response time, and tolerance for variations in diode characteristics over time and across the viewing area. Such a dual select diode liquid crystal display can also be relatively insensitive to propagation delays on the select and data lines and can therefore be scaled up to a very large area, for example, exceeding 40 inches in diagonal size.

According to the present disclosure, a single mask step can be used to build a dual select diode active matrix backplane. The one mask process is based on lateral nonlinear conduction in a suitable material, including, but not limited to, Zinc Oxide or other transparent semiconducting oxide films.

Transistor action has been proven with transparent oxides, including ZnO, ZnInO and ZnSnO, which have an energy bandgap exceeding 3 eV. This shows that these materials have semiconductor properties. Semiconductor two terminal devices can show nonlinear current-voltage characteristics or diode characteristics. The physical origin of this nonlinear behavior can be based on Frenkel-Poole conduction, Schottky effect, p-n junction formation, tunneling, or Space-Charge-Limited Conduction. When a diode ON current (e.g., at V>15 V) is high enough to charge the pixel and an OFF current (e.g., at V<5 V) is sufficiently low to retain charge on the pixel, the device can be applied as the switch in a dual select diode backplane.

Nonlinear resistors, or varistors, based on polycrystalline ZnO can be used as surge protectors and are often made by pressing and sintering ceramic material containing ZnO and additives. They have nonlinear current/voltage characteristics, following the equation:

I=cV^{α}

Where c is a constant and α is about 3 to 50. The higher values of α up to 50 can be obtained by adding materials such as Bi, Co, Cr, Mn and Sb to the ZnO.

Other materials, including nano-engineered materials, may also be used for the nonlinear conduction between the pixel and the select lines. For purposes of this disclosure, the phrase “lateral semiconducting material” will be used to broadly refer to Zinc Oxide or other materials that can be used to build the diodes of the dual select diode circuit.

FIG. 2 shows six pixels 40 built using the proposed one mask process. Pixels 40A, 40B, and 40C are addressed by select lines 50A and 50B; and pixels 40D, 40E, and 40F are addressed by select lines 50C and 50D. FIG. 3 shows a cross section of pixel 40A.

The pixels of FIGS. 2 and 3 can be built by depositing a lateral semiconducting material 70 on a glass substrate 72 as a blanket layer. The lateral semiconducting material does not need to be patterned. Materials such as Zinc Oxide do not significantly decrease transmission properties of the glass substrate.

A conducting material 74 can be deposited on the lateral semiconducting material. A nonlimiting example of a suitable conducting material is a transparent conducting oxide such as Indium Tin Oxide. The conducting material can be patterned into select lines (e.g., select lines 50A and 50B) and pixel electrodes (e.g., 40A). Another example of a transparent conducting layer for the select lines and the pixel electrodes is a very thin transparent film of Ag or a layer stack containing Ag. The interface between the Ag layer and ZnO layer may be optimized to obtain a Schottky diode with non-linear conduction.

No further depositing or patterning is necessary to complete the build of the backplane. The single mask process can form the pixel electrodes and the select lines, and the lateral semiconducting material at gaps between the select lines and the pixel electrodes can serve as diodes. For example, FIG. 2 shows diodes 60A, 60B, 60C, 60D, 60E, 60F, 60H, 60I, 60J, 60K, and 60L.

FIG. 3 shows that select line 50A is separated from pixel 40A by a channel with a gap distance G. G typically is set at about 0.5 μm to 20 μm, although other gap distances that allow suitable diode action are within the scope of this disclosure. The nonlinear conduction occurs in the layer of lateral semiconducting material proximate the channel, as is schematically represented by arrow 80.

It should be understood that sequencing in a one mask process can be reversed. For example, the pixel and select lines may be deposited and patterned first, and then the lateral semiconducting material can be deposited.

In some embodiments, a variation on the above described process can be implemented by using low-resistance metal select lines. FIG. 4 shows six pixels 100 built using such a process. Pixels 100A, 100B, and 100C are addressed by select lines 110A and 110B; and pixels 100D, 100E, and 100F are addressed by select lines 110C and 110D. Diodes 120A, 120B, 120C, 120D, 120E, 120F, 120H, 120I, 120J, 120K, and 120L are operatively intermediate the pixel electrodes and select lines, as described above with reference to FIGS. 2 and 3. FIG. 5 shows a cross section of pixel 100A.

The process for using low-resistance metal select lines also uses a single mask, but employs halftone exposure to pattern two layers with one photolithography step.

According to this process, the lateral semiconducting material 130 is deposited on a glass substrate 132 as a blanket layer. This is followed by deposition of a conducting layer 134 (e.g., transparent conducting oxide) and a metal layer 136. A mask then exposes the area between the pixels and select lines fully, the pixel electrode partially, and the select lines not at all. After exposure and developing, the photoresist can be removed from the areas between pixels and select lines, and the metal and conducting layer can be etched from these areas.

The half-exposed resist on the pixel electrode can then be etched back so that it is removed from the pixel electrodes, while the resist on part of the select lines remains. The metal is then etched from the pixels, so that the pixels become transparent, and the metal remains on the select lines. The process is completed by stripping the photoresist.

The proposed designs and processes are compatible with twisted nematic and multidomain vertical alignment liquid crystal modes of operation.

While the present invention has been described in terms of specific embodiments, it should be appreciated that the spirit and scope of the invention is not limited to those embodiments. The scope of the invention is instead indicated by the appended claims. All subject matter which comes within the meaning and range of equivalency of the claims is to be embraced within the scope of the claims.

1. A method of building an active matrix display backplane, comprising:
depositing a blanket layer of a lateral semiconducting material;
depositing a layer of a conducting material, where the lateral semiconducting material is adjacent the conducting material after both layers are deposited; and
patterning the conducting material into pixel electrodes and select lines, where the select lines are spaced from the pixel electrodes by a distance that allows the lateral semiconducting material to function as a diode between the select lines and the pixel electrodes.

2. The method of claim 1, where the lateral semiconducting material is substantially light transmissive.

3. The method of claim 1, where the lateral semiconducting material includes a transparent semiconducting oxide film.

4. The method of claim 1, where the lateral semiconducting material includes Zinc Oxide.

5. The method of claim 1, where the conducting material includes Indium Tin Oxide.

6. The method of claim 1, where the blanket layer of lateral semiconducting material is deposited before the layer of conducting material is deposited.

7. The method of claim 1, where the blanket layer of lateral semiconducting material is deposited after the layer of conducting material is deposited and patterned.

8. The method of claim 1, where the select lines are spaced from the pixel electrodes by about 0.5 μm to about 20 μm.

9. The method of claim 1, further comprising depositing a metal layer adjacent the conducting layer, and where patterning the conducting material into pixel electrodes and select lines includes fully exposing an area between pixels and select lines, partially exposing the pixel electrodes, and leaving the select lines unexposed.

10. A pixel circuit, comprising:
a capacitor having a pixel node and a data node;
a first select line spaced from the pixel node of the capacitor;
a second select line spaced from the pixel node of the capacitor; and
a semiconducting material selectively establishing a route of lateral conduction with diode action between the pixel node of the capacitor and the first select line and between the pixel node of the capacitor and the second select line.

11. The pixel circuit of claim 10, where the semiconducting material is substantially light transmissive.

12. The pixel circuit of claim 10, where the semiconducting material includes a transparent semiconducting oxide film.

13. The pixel circuit of claim 10, where the semiconducting material includes Zinc Oxide.

14. The pixel circuit of claim 10, where the first select line is spaced about 0.5 μm to about 20 μm from the pixel node of the capacitor.

15. The pixel circuit of claim 10, where the capacitor, the first select line, and the second select line include a patterned conducting material.

16. The pixel circuit of claim 15, where the patterned conducting material includes a transparent conducting oxide.

17. The pixel circuit of claim 15, where the patterned conducting material includes Indium Tin Oxide.

18. The pixel circuit of claim 15, where the select lines further include a metal layer.

19. A liquid crystal display, comprising:
a matrix of pixels arranged in rows and columns, each pixel including:
a capacitor having a pixel node and a data node;
a first select line spaced from the pixel node of the capacitor;
a second select line spaced from the pixel node of capacitor;
a semiconducting material selectively establishing a route of lateral conduction with diode action between the pixel node of the capacitor and the first select line and between the pixel node of the capacitor and the second select line; and
a data line operatively connected to the data node of the capacitor; and
an addressing system selectively controlling voltages at the select lines and the data line of each pixel so as to selectively charge the capacitor of each pixel.
